(19) United States
(12) Patent Application Publication
(10) Pub. No.: US 2006/0027014 A1
(43) Pub. Date: Feb. 9, 2006

(54) Apparatus and method for water sorption measurement

(75) Inventor: Seymour Lowell, Boynton Beach, FL (US)

Correspondence Address: ROBERT M. SCHWARTZ, P.A., P.O. BOX 221470, HOLLYWOOD, FL, 33022, US

(73) Assignee: Quantachrome Corporation

(21) Appl. No.: 11/196,697

(22) Filed: Aug. 3, 2005

Related U.S. Application Data
(60) Provisional application No. 60/598,597, filed on Aug. 3, 2004.

(51) Int. Cl. G01N 15/08

(52) U.S. Cl. 73/38

(57) ABSTRACT

An apparatus for sorption analysis includes a manifold, at least one sample cell to hold at least one sample under test, and a sorbable gas supply. At least one pressure measurement device is provided to monitor manifold pressure and sample cell pressure. A plurality of supply lines connect the at least one sample cell, the sorbable gas supply, the at least one vacuum supply, and the manifold. A plurality of isolation valves are connected within the plurality of supply lines. At least one isolation valve is connected between the at least one pressure measurement device and the manifold, and between the at least one pressure measurement device and the at least one sample cell. At least one vacuum supply evacuates the manifold, the at least one sample cell, the plurality of supply lines, the plurality of isolation valves, and the at least one pressure measurement device. The apparatus minimizes errors associated with sorption measurements on sample material at temperatures below the critical temperature of the sorbable gas supply.

### CROSS-REFERENCE TO RELATED APPLICATION:

This application claims the benefit of U.S. Provisional Application Ser. No. 60/598,597, filed on Aug. 3, 2004, entitled APPARATUS AND METHOD FOR WATER SORPTION MEASUREMENT; the prior application is herewith incorporated by reference in its entirety.

### BACKGROUND OF THE INVENTION

1. Field of the Invention

A vacuum-volumetric water vapor sorption measurement system and method is described whereby isotherms can be generated and sample characteristics calculated. These characteristics include surface area, pore volume, pore size and differential heat of adsorption. Two different system architecture designs are described with variations in pressure transducer quantity and sensitivity and accompanying changes to the isolation valves. The primary embodiment describes the operation of a system design using a single pressure transducer with a three-way valve operatively connected to permit switching between a pressure manifold and a sample cell for making pressure measurements. Another embodiment describes the use of two pressure transducers and two two-way valves in place of the single pressure transducer and three-way valve of the primary embodiment.

2. Description of the Related Art

Objects exposed to the earth's atmosphere are continuously in contact with water vapor to some degree. In atmospheric science, relative humidity values define the content of water in the air. The interaction of water with a variety of objects is of interest to Industry for product performance and quality assurance considerations. Food products, cosmetics, and pharmaceuticals, for example, may degrade as a result of chemical reaction and mold growth or textural changes may occur in the presence of water. Building material manufacturers may need information about the effects of humidity on various grades of cement, and industries involved with leading-edge technologies in fields of desiccant, battery oxide, and textile design find water adhesion of key interest.

Water vapor sorption can be described by two events, adsorption and desorption. Adsorption is defined as the affinity of molecules to adhere to the surface of a solid, while desorption is the propensity of molecules to be released from the surface of a solid. Van der Waal forces, hydrogen bonds and other electrostatic forces are responsible for holding the water molecules to the surface of a solid during adsorption. Depending on the chemical composition of the solid, other types of bonding may take place including bonding with hydroxyl groups, and bonding to form hydroxides or hydrates. Water adsorption is proportional to the affinity between the surface of a solid and the water molecules, the temperature, the pressure, and the surface area exposed.

The relationship between adsorption (desorption) quantity on (from) a solid and relative pressure of water vapor is characterized by a water vapor sorption isotherm. Using isotherm data, it is possible to estimate the moisture activity of a solid at a particular temperature and relative humidity. Surface area, pore volume, pore size, and the differential heat of adsorption information can all be determined by characterizing the response of the solid to humidity using one or a set of isotherm graphs.

Measurement and characterization of the attraction between vapor and solids is the subject of the present invention. Prior-art water sorption measurement methods include microbalance gravimetry, ellipsometry, and vacuum-volumetric analysis. Microbalance gravimetry measures minute changes in weight of samples in the presence of humidity, while ellipsometry correlates changes in optical properties of a measured sample with adsorption. Difficulties with these methods include accuracy, sensitivity, calibration, lengthy setup and measurement periods, and in the case of ellipsometry, restrictions on the types of samples that can be measured. The vacuum-volumetric approach is highly sensitive due to measurements of adsorption based on small vapor pressure changes over the sample.

Vacuum-volumetric analyses of adsorption and desorption has previously been described in patents issued to Lowell including U.S. Pat. No. 3,555,912, U.S. Pat. No. 4,566,326, U.S. Pat. No. 5,360,743, and U.S. Pat. No. 5,895,841. Adsorption and desorption isotherms are prepared by comparing volume versus equilibrium relative pressure for a known quantity of an adsorbable gas, such as Nitrogen, on the material under test. The measurements can be repeated at various temperatures in order to generate multiple representative isotherms for the material. These isotherms reveal surface area and porosity information. Although a vapor is defined as the gaseous state of a substance below its critical temperature (that temperature above which a phase change to liquid cannot occur no matter how much pressure is applied), the words “gas” and “vapor” will be used interchangeably herein. Furthermore, the words “partial pressure” and “relative pressure” will also be used interchangeably herein.

The measurement process involves setup of a system of calibrated volume and temperature whereby partial pressure of an adsorbable gas is compared with and without the presence of the sample under test. Adsorption of the gas by the material under test results in a reduction in pressure. The difference in pressure between the system with and without the presence of the sample is proportional to the volume of gas adsorbed by the sample under test. Vacuum-volumetric systems of prior-art references listed in the previous paragraph indicate significant design effort that has been invested in producing a system that is quick to calibrate, temperature stable, and offers high sample throughput.

These prior-art systems, however, were designed to operate with gases, such as Nitrogen, at temperatures above the critical temperature so that condensation on component surfaces would not occur and undesirable adsorption on system components would be minimized. Condensation and adsorption can introduce errors in the measurement process by desorbing from component inner surfaces during sample testing, thereby introducing gas molecules that are unaccounted for by system calibration. Furthermore, because the critical temperature of Nitrogen is −147 degrees Centigrade (deg. C.), the systems generally operate at temperatures considerably above this value. As a result, availability of moderately priced high precision components such as pressure transducers, and switches for systems that use Nitrogen, as an adsorbate is not a problem.

The present invention relates to a vacuum-volumetric water sorption measurement system. Water has a critical temperature of 374.1 deg. C., which is much higher than gases such as Nitrogen. As such, condensation and adsorption can occur on components below this temperature. While it is possible to maintain the system, including all components in contact with the adsorbate at temperatures above the critical temperature, the cost of high precision components that can operate at these temperatures for prolonged periods of time becomes prohibitive. The challenge, therefore, is to reduce the measurement errors that can be introduced from desorption of water from system components during testing while operating the system at temperatures much lower than the critical temperature in order to minimize component costs. The present invention achieves these objectives.

### SUMMARY OF THE INVENTION

It is accordingly an object of the invention to provide an apparatus and method for water sorption measurement, which overcomes the above-mentioned disadvantages of the heretofore-known devices of this general type.

With the foregoing and other objects in view there is provided, in accordance with the invention an apparatus for sorption analysis including a manifold, at least one sample cell to hold at least one sample under test, and a sorbable gas supply. At least one pressure measurement device is provided to monitor manifold pressure and sample cell pressure. A plurality of supply lines connect the at least one sample cell to the manifold, the sorbable gas supply to the manifold, the at least one vacuum supply to the manifold, the at least one pressure measurement device to the manifold, and the at least one pressure measurement device to the at least one sample cell. A plurality of isolation valves are connected within each of the plurality of supply lines between the cell and the manifold, between the sorbable gas supply and the manifold, and between the at least one vacuum supply and the manifold. At least one isolation valve is connected between the at least one pressure measurement device and the manifold, and between the at least one pressure measurement device and the at least one sample cell. At least one vacuum supply evacuates the manifold, the at least one sample cell, the plurality of supply lines, the plurality of isolation valves, and the at least one pressure measurement device. The apparatus minimizes errors associated with sorption measurements on sample material at temperatures below the critical temperature of the sorbable gas supply.

In accordance with another feature of the invention, the manifold void volume is calibrated.

In accordance with a further feature of the invention, the at least one sample cell void volume is calibrated.

In accordance with an added feature of the invention, the at least one isolation valve connected between the at least one pressure measurement device and the manifold, and between the at least one pressure measurement device and the at least one sample cell is a three-way isolation valve connected between each of the at least one sample cell, the manifold, and the at least one pressure measurement device. The three-way isolation valve allows switching between manifold pressure measurement and each of the at least one sample cell pressure measurement.

In accordance with an additional feature of the invention, the at least one isolation valve connected between the at least one pressure measurement device and the manifold, and between the at least one pressure measurement device and the at least one sample cell is an N-way isolation valve connected between each of the at least one sample cell, the at least one pressure measurement device, and the manifold. The N-way isolation valve allows switching between manifold pressure measurement and each of the at least one sample cell pressure measurement.

In accordance with another mode of the invention, the at least one isolation valve is connected between each of the at least one pressure measurement device and the manifold. At least one isolation valve is connected between each of the at least one pressure measurement device and the at least one sample cell.

Other features which are considered as characteristic for the invention are set forth in the appended claims.

Although the invention is illustrated and described herein as embodied in an apparatus and method for water sorption measurement, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a schematic view of the water vapor sorption system incorporating a three-way valve;

FIG. 2a is a flowchart indicating the water vapor adsorption measurement method of the first embodiment of the present invention;

FIG. 2b is a continuation of the flowchart of FIG. 2a, indicating the water vapor adsorption measurement method of the first embodiment of the present invention;

FIG. 3 is a schematic view of the water vapor sorption system using two two-way valves and dual pressure transducers in place of the single three-way valve; and

FIG. 4 is a plot of an isotherm, type II resulting from testing of a sample in the system.

### DESCRIPTION OF THE PREFERRED EMBODIMENTS

The present invention details vacuum-volumetric analysis systems that operates using vapors, particularly water vapor in order to promote sorption on samples. It measures changes in pressure resulting from adsorption of vapor on a sample surface. Primary and secondary embodiments are described, wherein the pressure transducers preferentially record absolute pressure within an isolated sample cell, thereby minimizing measurement errors resulting from desorption off of system components. The resolution of the system is on the order of 0.05 to 0.005 mg sorbed water, and adsorption of the vapor is rapid. The analysis period is significantly shorter than that performed by gravimetry, since those systems have large sample cells that promote adsorption on the cell surfaces. This increases the time for equilibrium to be established, and since valid data points are only established at equilibrium, sample-testing periods tend to be longer for gravimetric systems. Moreover, current gravimetric systems are prone to measurement errors due to uncalibrated desorption from cell surfaces. The vacuum-volumetric approach of the present invention also offers an advantage over ellipsometry because it can be used with a wider range of sample types.

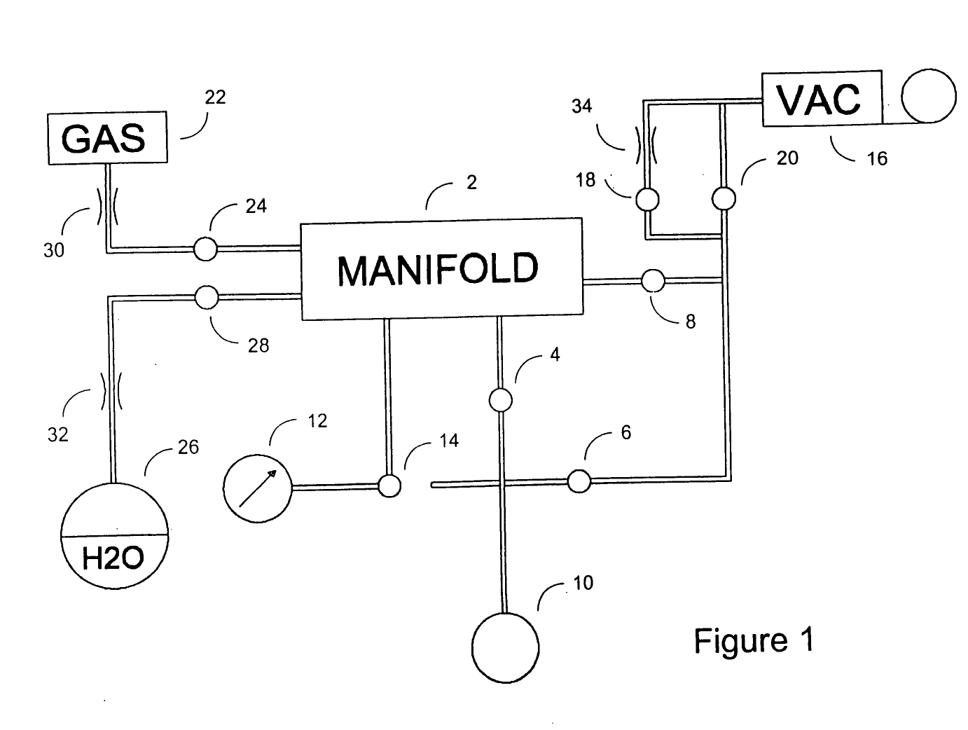

FIG. 1 shows a schematic diagram of the system components for the first embodiment of the present invention. An information processor and system controller is not pictured in this diagram, however a processor monitors received input from temperature sensors and pressure transducers and outputs control signals to valves, pumps, and an oven. The processor is also responsible for calculations involving received data from the system. As used herein, the terms “processor” and “controller” can be used interchangeably and include members of the group comprising microprocessors, microcontrollers, and digital signal processors. The terms “sample cell” and “cell” are used synonymously. Terms such as “recorded”, and “stored” can comprise storage of data in primary memory, secondary memory, cache memory, or can be defined as output of information to a recording device such as a printer or plotter.

As shown, the system encompasses a manifold 2 connected by coupling lines through a plurality of isolation valves 4, 6, 8 with a sample cell 10. An absolute pressure transducer 12 operatively connected to a three-way valve 14 is provided to measure the manifold pressure. The pressure transducer 12 is also coupled through the three-way valve 14 to the sample cell 10 to provide pressure measurements of the cell. Pressure transducers of various sensitivities can be fitted to the system to accommodate specific needs of the user. A common vacuum pump 16 is connected by coupling lines through isolation valves 18, 20, 6, and 8 to the manifold and sample cell. Nitrogen gas is supplied from container 22 through a coupling line and an isolation valve 24 to the manifold. The Nitrogen gas is used to calibrate pressure transducers and to determine the various void volumes within the system. Water vapor is supplied from an oven heated water reservoir 26 to the manifold through a coupling line and an isolation valve 28. Gas and water vapor flow control is provided by needle valves 30 and 32. Needle valve 34 is provided on the coupling line leading from the vacuum pump to prevent elutriation of samples of low mass and poor adhesion, such as a fine powder, during system evacuation.

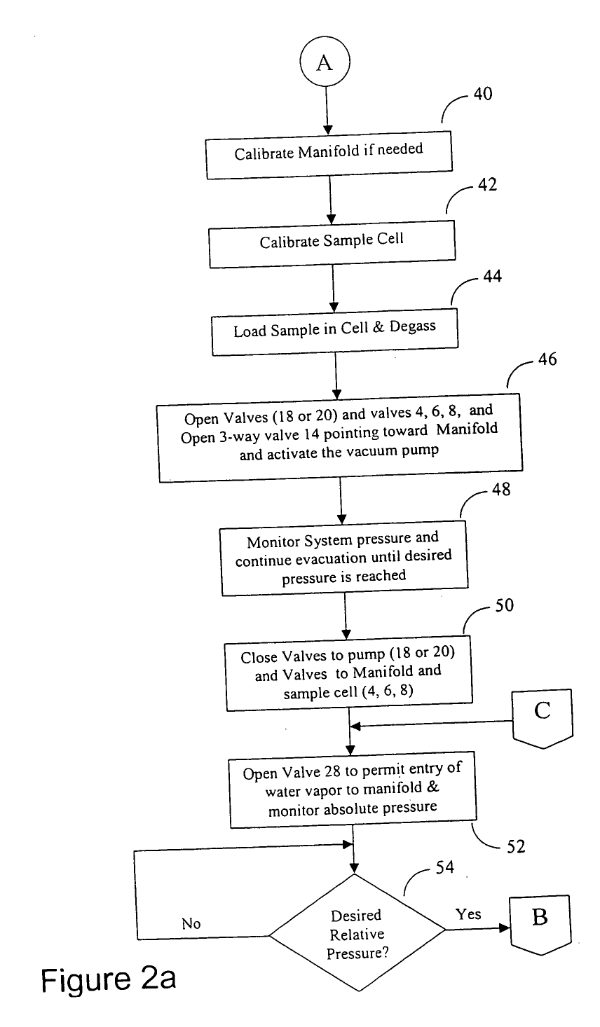

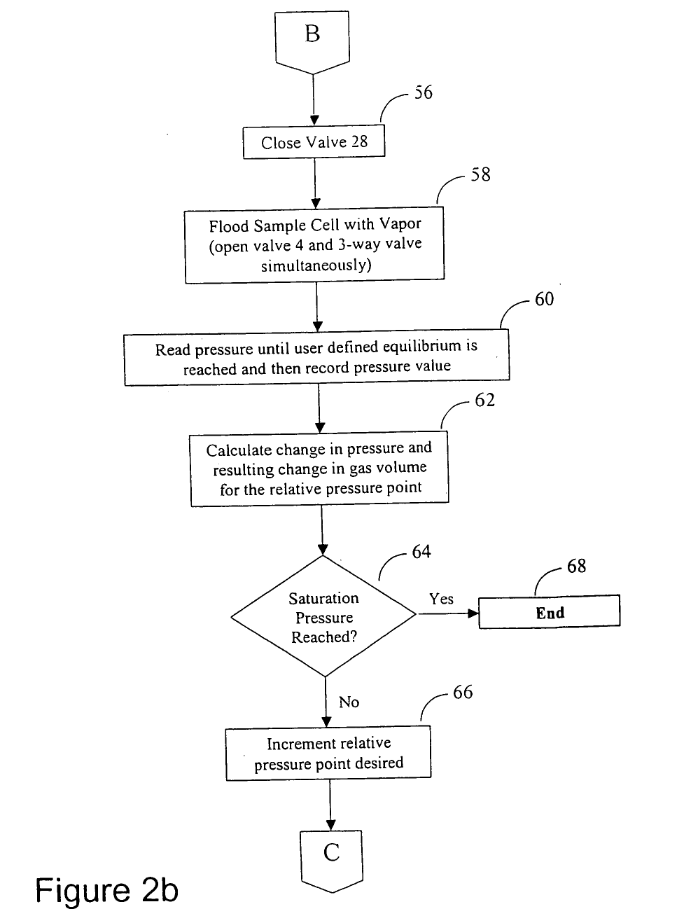

Referring to FIG. 1 and the flowchart of FIG. 2a and FIG. 2b, operation of the system begins with calibration of the manifold, indicated in box 40 of FIG. 2a, and calibration of the sample cell 10, box 42. The manifold 2 does not require calibration each time a measurement is performed, but rather only need be done periodically. Manifold 2 calibration is performed using a calibration rod of known volume in a temperature-stabilized system. Calibration of the sample cell 10 is performed with water vapor, without a sample in place and is necessary for obtaining accurate cell volume readings. Volume is measured for each temperature wherein an isotherm is to be determined. These cell calibrations are stored and accessible to the controller as needed. Thereafter, the sample is placed in the calibrated cell and degassed by flow or vacuum to remove contaminants and unwanted vapors at a temperature above the analysis temperature, box 44. The cell with the sample in place is weighed after degassing to determine an accurate sample starting weight. Except for the cell and the sample, measurement and analysis is preferentially performed with the entire system set at 100 deg. C. Note that sorption measurement and analysis at system temperatures other than 100 deg. C. is supported by the system design of the included embodiments herein. The cell with the sample therein is immersed in a temperature stabilized water bath at a user-preferred temperature between 12 and 47 deg. C.

Initially the system is pumped down to a user selected pressure by operating the Vacuum Pump 16 and opening isolation valves 18 or 20, 4, 6, 8 and three-way valve 14 is directed toward the manifold, as described in box 46. Note that absolute pressure transducer 12 reads either manifold pressure or cell pressure depending upon the position of three-way valve 14. When the pressure in the system has stabilized and reached the desired evacuation level, isolation valves 18 or 20, 4, 6, and 8 are closed, box 48 and box 50. The three-way isolation valve 14 remains open and switched toward the manifold. Thereafter, isolation valve 28 is opened, allowing water vapor to pervade the manifold 2, box 52. When a desired relative pressure is reached, box 54, isolation valve 28 is closed, box 56 of FIG. 2b. Essentially simultaneously, isolation valve 4 is opened and three-way valve 14 is switched open toward the sample cell 10, allowing vapor to flow toward the sample and pressure to be read by the transducer 12, box 58. After approximately six seconds, enough time for vapor pressure to rise to the desired level, isolation valve 4 is closed but pressure transducer 12 continues reading pressure in the sample cell 10 on a regular basis and sends the signals to the processor for storage and evaluation. Initially, pressure in the cell 10 is equivalent to pressure in the manifold 2 however, after a period of time the pressure begins to drop as water molecules adsorb on the sample and cell wall. Transducer 12 continues performing and transmitting measurements periodically until equilibrium pressure is obtained, box 60. Equilibrium is user defined by a previously set threshold level for change in pressure with time. As gas is adsorbed, the relative pressure drops and it is this drop in pressure at equilibrium that determines the molar concentration of gas that has been adsorbed by the sample. This molar concentration is converted to volume using the relationship where one mole of gas occupies 22.414 liters of volume at Standard Temperature and Pressure (STP), including a small correction factor to compensate for the non-ideal behavior of water vapor. At equilibrium pressure, the number of vapor molecules adsorbed by the cell 10 and sample combined is equivalent to the number of vapor molecules desorbed by the cell 10 and the sample combined. In calculating adsorption volume, the influence of adsorption on the cell wall is adjusted by subtracting the cell calibration values previously stored in system memory from the measured values, box 62. If the processor determines that saturation pressure, P₀, has not yet been reached, box 64, successive pressure measurements are performed for desired relative pressures, P/P₀, box 66, by repeating the previous steps as shown in FIG. 2b by continuation connector “C”. Note that by reconfiguring the three-way valve to read manifold pressure, additional water vapor is permitted to enter the manifold through isolation valve 28 until a successive desired relative pressure is reached. This cumulative technique works because the number of water molecules adsorbed by the surface of the solid is proportional to the molar concentration of water molecules in the gas phase above the sample. If saturation pressure is reached, the process is ended, box 68, data is analyzed and an isotherm plot is generated.

The use of a three-way valve 14 is of particular significance in this application. When vapor is admitted to the cell from the manifold, some molecules desorb from the manifold walls and also enter the cell. These cannot be accounted for by any pressure change within the manifold. Thus, when isolation valve 4 is opened, it is for a very short time, about 5-6 seconds, and then closed. This does not give adsorbed molecules sufficient time to desorb to a lower equilibrium value within the manifold. Therefore, the molecules reaching the cell are virtually all from the vapor phase within the manifold, thereby rendering accurate pressure differences and consequently more accurate adsorption data. During desorption, the short time isolation valve 4 is opened does not give ample time for adsorption on the manifold walls to reach an equilibrium value, again rendering more accurate pressure measurements. In each case, i.e. for adsorption and desorption, three-way valve 14 is immediately switched, after a manifold pressure reading is taken, back to the cell in order to monitor when equilibrium is achieved.

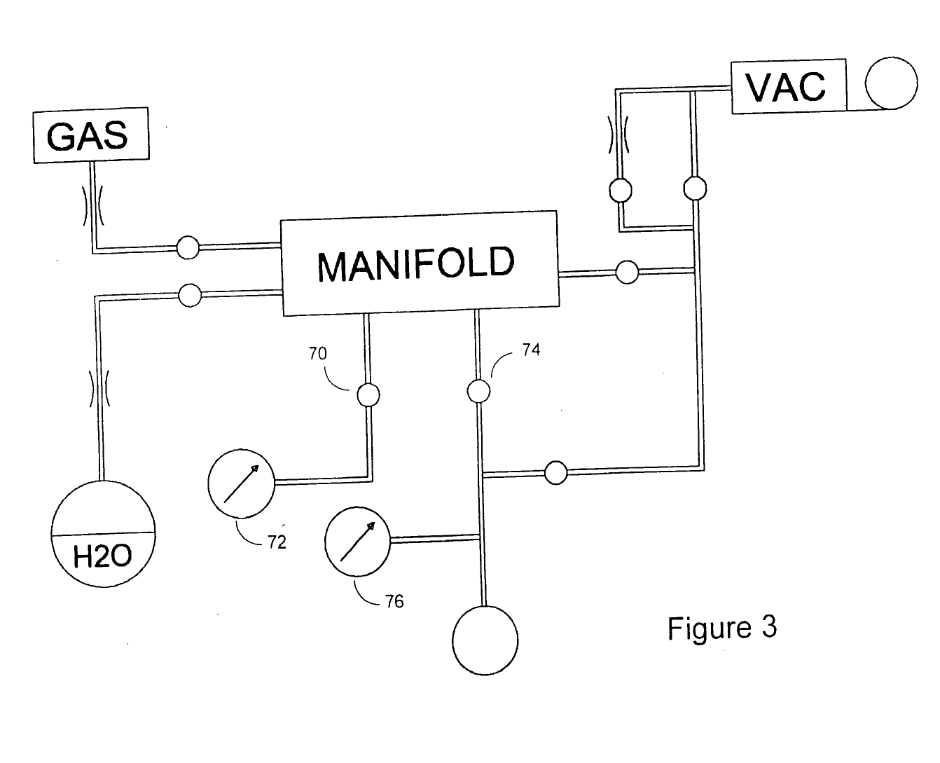

A second embodiment of the present invention, shown in FIG. 3, uses two two-way valves and two pressure transducers in place of the single three-way valve 14 and pressure transducer 12 described in the preceding paragraphs. Only one two-way valve is added to the system because of the existence of isolation valve 4, shown in the primary embodiment. The configuration of the balance of the system components in the second embodiment is the same as the first embodiment. Operation of the system shown in FIG. 3 is similar to that described in the preceding paragraphs and outlined in FIGS. 2a and 2b, except that where the three-way valve 14 is configured to allow pressure transducer 12 to read manifold 2 pressure in the first embodiment, valve 70 is opened allowing dedicated pressure transducer 72 to read manifold 2 pressure in this embodiment. Furthermore, where the three-way valve 14 is configured to allow pressure transducer 12 to read sample cell 10 pressure in the first embodiment, isolation valve 70 is closed and isolation valve 74 is opened to allow dedicated pressure transducer 76 to read sample cell 10 pressure in this embodiment. All other operating conditions remain unchanged between the two embodiments. While it is known in the art to use two (dual) transducers in vacuum-volumetric systems with other gas systems, the reasoning for use of said transducers differ. Dual pressure transducer use in the prior-art is to increase sensitivity of the system, while dual transducer use in the present system embodiment minimizes uncompensated sample cell 10 measurement errors introduced by desorption of water vapor from large system components, such as the manifold 2 during adsorption measurements. The over-riding advantage, therefore, of the presented system architecture is the measurement accuracy introduced by reducing the number and surface area of components in contact with a minimized volume of adsorbate, while keeping operating temperatures significantly lower than the critical temperature. Component costs are reduced as a result of decreased operating temperature. The three-way valve design, as described in the first embodiment is preferred over the dual transducer design because of the disadvantages of extra cost (pressure transducers that operate within the required specifications currently sell for about $1000.00 each), the difficulty of matching transducer sensitivities, and measurement errors introduced by additional desorption from within the multiple transducers.

Desorption occurs in essentially the opposite manner to adsorption. Desorption measurements are generally begun at saturation and proceed as relative pressure is decreased in discrete steps. Assume that cell 10, of FIG. 1, begins at a pressure equal to saturation. The vapor pressure in the manifold 2 is decreased to a desired relative pressure below saturation by operating vacuum pump 16, opening isolation valve 8, and opening flow controlled isolation valve 18, with valves 4 and 6 closed, thereby dropping pressure to the desired value, whereupon valves 8 and 18 are closed. Cell 10 retains saturation pressure until three-way valve 14 is switched open toward the cell, and isolation valve 4 is opened. The cell partial pressure initially drops to the relative pressure found in the manifold 2, however as desorption proceeds, the partial pressure increases. At equilibrium, the absolute pressure is recorded and valve 4 is closed. The process is repeated for all relative pressures of interest to the user. Thereafter, calculations are performed to determine the desorption profile for the material under test. Note that during measurement of desorption isotherms, adsorption of water vapor on component surfaces is problematic. Since the present invention reduces component surface area in contact with a minimized adsorbate, the measurement accuracy is increased for these types of measurements also.

Isotherm graphs can be derived from the changes in relative pressure obtained for the samples under test. The standard ideal gas relationship, PV=nRT, is used but in a slightly changed form to reflect the system operation. A change in pressure, ΔP, as a result of adsorption and desorption is caused by a change in molar concentration, Δn, of the gas. Hence the working relationship becomes (ΔP)V=(Δn)RT where the volume of the system, V, the universal gas constant, R, and the temperature, T, are constant for a given isotherm and gas type. Isotherm graphs often plot gas volume versus relative pressure, where gas volume is derived from molar concentration by the relationship that a gas occupies 22.414 liters of volume per mole at STP. Compensation is provided for non-ideal conditions of the vapor.

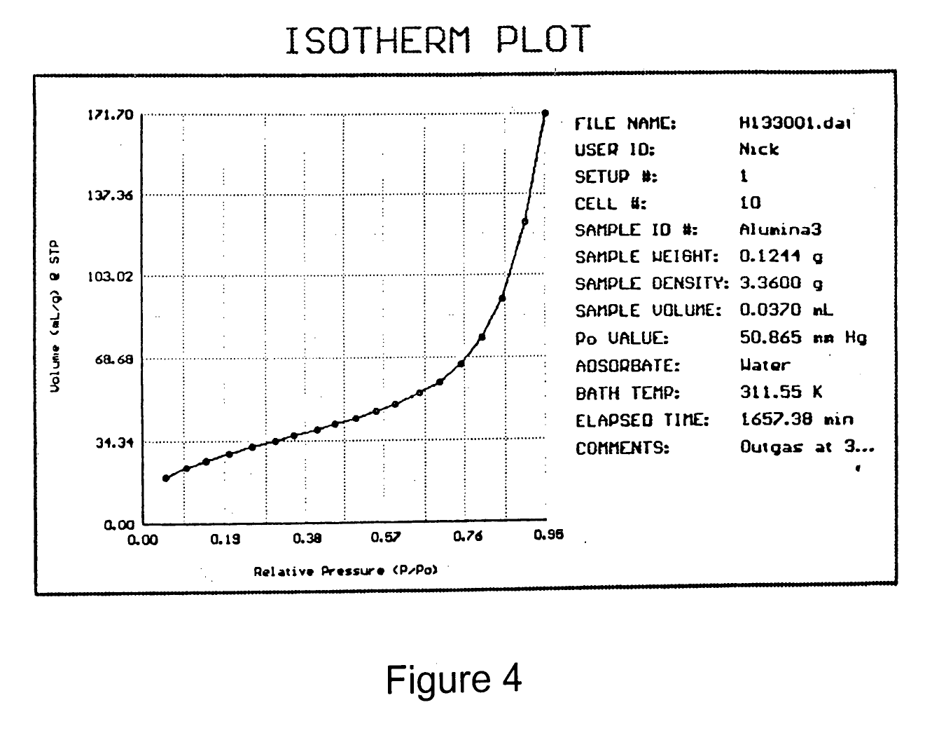

Using the measured data and the relationships given above, isotherms can be plotted from experimental data and modeled by Langmuir, and Brunauer, Emmett, Teller (BET) relationships. FIG. 4 shows a typical plot of gas volume versus relative pressure for a sample under test. This material exhibits behavior characteristic of type II, indicating a porous and hydrophilic substance. Comparing plots of experimental data with characteristics curves of Type I through Type V isotherms, can help to identify the behavior of a sample material as hydrophilic, hydrophobic, with and without micropores, and whether oxides are present. Further calculations using experimental data include surface area calculation using the BET computation method along with the weight of vapor absorbed; pore volume and pore size knowing the vapor adsorbed and the surface area as calculated by the BET method. The differential heat of adsorption is obtained from a pair of isotherms at differing temperatures, using the differential equilibrium pressures of the two isotherms.

While the described first and second embodiments detail systems with only one sample cell, yet a third embodiment of the present invention could encompass designs comprising a plurality of sample cells along with accompanying coupling lines, manifolds, supply lines, isolation valves, pressure transducers, pumps, and gases. These multiple sample test systems would increase both complexity and throughput. Under such a scenario, there may be a plurality of sample cells, where a single N-way isolation valve (N is greater than 3) may be used in place of multiple single isolation or 3-way valves to switch between pressure measurement of the manifold and any one of the sample cells.

Although the invention has been described in connection with various specific embodiments thereof, it should be appreciated that various modifications and adaptations can be made without departing from the scope thereof.

I claim:

1. An apparatus for sorption analysis comprising:
a manifold;
at least one sample cell to hold at least one sample under test;
a sorbable gas supply;
at least one pressure measurement device to monitor manifold pressure and sample cell pressure;
a plurality of supply lines connecting said at least one sample cell to said manifold, said sorbable gas supply to said manifold, said at least one vacuum supply to said manifold, said at least one pressure measurement device to said manifold, and said at least one pressure measurement device to said at least one sample cell;
a plurality of isolation valves connected within each of said plurality of supply lines between said cell and said manifold, between said sorbable gas supply and said manifold, and between said at least one vacuum supply and said manifold;
at least one isolation valve connected between said at least one pressure measurement device and said manifold, and between said at least one pressure measurement device and said at least one sample cell; and
at least one vacuum supply for evacuating said manifold, said at least one sample cell, said plurality of supply lines, said plurality of isolation valves, and said at least one pressure measurement device;
wherein said apparatus minimizes errors associated with sorption measurements on sample material at temperatures below the critical temperature of said sorbable gas supply.

2) The apparatus of claim 1 wherein said manifold void volume is calibrated.

3) The apparatus of claim 1, wherein said at least one sample cell void volume is calibrated.

4) The apparatus of claim 1, wherein said at least one isolation valve connected between said at least one pressure measurement device and said manifold, and between said at least one pressure measurement device and said at least one sample cell is a three-way isolation valve connected between each of said at least one sample cell, said manifold, and said at least one pressure measurement device, allowing switching between manifold pressure measurement and each of said at least one sample cell pressure measurement.

5) The apparatus of claim 1, wherein said at least one isolation valve connected between said at least one pressure measurement device and said manifold, and between said at least one pressure measurement device and said at least one sample cell is an N-way isolation valve connected between each of said at least one sample cell, said at least one pressure measurement device, and said manifold, allowing switching between manifold pressure measurement and each of said at least one sample cell pressure measurement.

6) The apparatus of claim 1, wherein at least one isolation valve is connected between each of said at least one pressure measurement device and said manifold, and at least one isolation valve is connected between each of said at least one pressure measurement device and said at least one sample cell.
